(19) United States
(12) Patent Application Publication
(10) Pub. No.: US 2020/0183729 A1
(43) Pub. Date: Jun. 11, 2020

(54) EVOLVING HYPERVISOR PASS-THROUGH DEVICE TO BE CONSISTENTLY PLATFORM-INDEPENDENT BY MEDIATED-DEVICE IN USER SPACE (MUSE)

(71) Applicants: Xiuchun Lu, Shanghai (CN); Cunming Liang, Shanghai (CN); Shaopeng He, Shanghai (CN); Nrupal Jani, Hillsboro, OR (US); Anjali Jain, Portland, OR (US); Edwin Verplanke, Chandler, AZ (US); Parthasarathy Sarangam, Portland, OR (US); Zhirun Yan, Shanghai (CN)

(72) Inventors: Xiuchun Lu, Shanghai (CN); Cunming Liang, Shanghai (CN); Shaopeng He, Shanghai (CN); Nrupal Jani, Hillsboro, OR (US); Anjali Jain, Portland, OR (US); Edwin Verplanke, Chandler, AZ (US); Parthasarathy Sarangam, Portland, OR (US); Zhirun Yan, Shanghai (CN)

(21) Appl. No.: 16/738,034

(22) Filed: Jan. 9, 2020

Related U.S. Application Data
(60) Provisional application No. 62/928,357, filed on Oct. 31, 2019.

(51) Int. Cl. G06F 9/455; G06F 9/445

(52) U.S. Cl. CPC G06F 9/45558; G06F 2009/4557; G06F 9/445

(57) ABSTRACT

Methods and apparatus for evolving hypervisor pass-through devices supporting platform independence through a core solution called MUSE (Mdev in User SpacE) that allows mediated pass-through device being served by software running in user space. The MUSE architecture supports platform hardware independence while providing pass-through performance similar to hardware-specific solutions and providing enhanced performance in virtualized environments using existing software components, including various operating systems and associated libraries for implementing SDN (Software Defined Networking) and VNF (Virtualized Network Function).

### CROSS-REFERENCE TO RELATED APPLICATION

This application claims the benefit of the filing date of U.S. Provisional Application No. 62/928,357, filed Oct. 31, 2019, entitled “EVOLVING HYPERVISOR PASS-THROUGH DEVICE TO BE CONSISTENTLY PLATFORM-INDEPENDENT BY MEDIATED-DEVICE IN USER SPACE (MUSE)” under 35 U.S.C. § 119(e). U.S. Provisional Application No. 62/928,357 is further incorporated herein in its entirety for all purposes.

### BACKGROUND INFORMATION

During the past decade, there has been tremendous growth in the usage of so-called “cloud-hosted” services. Examples of such services include e-mail services provided by Microsoft (Hotmail/Outlook online), Google (Gmail) and Yahoo (Yahoo mail), productivity applications such as Microsoft Office 365 and Google Docs, and Web service platforms such as Amazon Web Services (AWS) and Elastic Compute Cloud (EC2) and Microsoft Azure. Cloud-hosted services are typically implemented using data centers that have a very large number of compute resources, implemented in racks of various types of servers, such as blade servers filled with server blades and/or modules and other types of server configurations (e.g., 1U, 2U, and 4U servers).

In recent years, virtualization of computer systems has seen rapid growth, particularly in server deployments and data centers. Under a conventional approach, a server runs a single instance of an operating system directly on physical hardware resources, such as the CPU, RAM, storage devices (e.g., hard disk), network controllers, IO ports, etc. Under one virtualized approach using Virtual Machines (VMs), the physical hardware resources are employed to support corresponding instances of virtual resources, such that multiple VMs may run on the server's physical hardware resources, wherein each virtual machine includes its own CPU allocation, memory allocation, storage devices, network controllers, IO ports etc. Multiple instances of the same or different operating systems then run on the multiple VMs. Moreover, through use of a virtual machine manager (VMM) or “hypervisor,” the virtual resources can be dynamically allocated while the server is running, enabling VM instances to be added, shut down, or repurposed without requiring the server to be shut down. This provides greater flexibility for server utilization, and better use of server processing resources, especially for multi-core processors and/or multi-processor servers.

Under another virtualization approach, container-based OS virtualization is used that employs virtualized “containers” without use of a VMM or hypervisor. Instead of hosting separate instances of operating systems on respective VMs, container-based OS virtualization shares a single OS kernel across multiple containers, with separate instances of system and software libraries for each container. As with VMs, there are also virtual resources allocated to each container.

Deployment of Software Defined Networking (SDN) and Network Function Virtualization (NFV) has also seen rapid growth in the past few years. Under SDN, the system that makes decisions about where traffic is sent (the control plane) is decoupled for the underlying system that forwards traffic to the selected destination (the data plane). SDN concepts may be employed to facilitate network virtualization, enabling service providers to manage various aspects of their network services via software applications and APIs (Application Program Interfaces). Under NFV, by virtualizing network functions as software applications, network service providers can gain flexibility in network configuration, enabling significant benefits including optimization of available bandwidth, cost savings, and faster time to market for new services.

NFV decouples software (SW) from the hardware (HW) platform. By virtualizing hardware functionality, it becomes possible to run various network functions on standard servers, rather than purpose built HW platform. Under NFV, software-based network functions run on top of a physical network input-output (IO) interface, such as by NIC (Network Interface Controller), using hardware functions that are virtualized using a virtualization layer (e.g., a Type-1 or Type-2 hypervisor or a container virtualization layer). However, network interfaces generally remain vendor-specific, which means the network function still require some level of hardware platform dependency.

When NFV stays in the virtualization stage, it demands to run network functions in virtual machines (VM)s with almost the same IO performance as running on native hardware. As a result, use of pass-through VFs (virtual functions) populated by single-root input/output virtualization (SR-IOV) to VM becomes the preferred choice for IO virtualization. However, when NFV moves towards a cloud-ready stage, pass-through methods have a few drawbacks. For example, when performing live migration, the hypervisor is not aware of device stats that are passed through to the VM and transparent to the hypervisor. Hence, the NIC hardware design must take live migration into account. However, even though such workarounds provided with NIC hardware designs may be used to solve specific problems, this approach often creates new additional problems.

In addition, there is limited cross-platform compatibility among IO devices from different vendors, since NICs and the like from different vendors often use proprietary interfaces. For example, a VNF (Virtualized Network Function) built to support a NIC from vendor A may not be able to be deployed on a platform using a NIC from vendor B. Even NICs from the same vendor may have cross-platform incompatibilities.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram illustrating a mediated pass-through architecture with a multi-instance software parent device, according to one embodiment;

FIG. 1a is a schematic diagram illustrating an augmented version of the mediated pass-through architecture of FIG. 1 including a physical IO device and further details of user-space memory;

FIG. 2 is a diagram depicting selected components in the architecture of FIG. 1 associated with MUSE operations;

FIG. 3 is a flowchart illustrating operations associated with mediated device life-cycle management, according to one embodiment;

FIG. 4 is a flowchart illustrating operations associated with configuration space setup and IO port space setup, according to one embodiment;

FIG. 5 is a flowchart illustrating operations associated with setup of a MMIO space, according to one embodiment;

FIG. 6 is a flowchart illustrating operations associated with DMA mapping setup, according to one embodiment;

FIG. 7 is a flowchart illustrating operations associated with interrupt delivery setup, according to one embodiment;

FIG. 8 is a schematic diagram of a platform architecture configured to implement the software architecture shown in FIG. 1 using a System on a Chip (SoC) connected to a NIC, according to one embodiment;

FIG. 8a is a schematic diagram of a platform architecture similar to that shown in FIG. 8 in which the NIC is integrated in the SoC;

FIG. 9 is a flowchart illustrating operations for processing a packet received by NIC when the guest device driver does not support the NIC, according to one embodiment;

FIG. 10a is a schematic diagram illustrating a NIC coupled to a plurality of hosts in a platform;

FIG. 10b is a schematic diagram illustrating a NIC in a first slot or chassis of a rack coupled in communication with one or more hosts in a second slot or chassis of the rack via a fabric; and

FIG. 11 is a block diagram of a Linux KVM (Kernel-based Virtual Machine) architecture used to host multiple virtual machines.

### DETAILED DESCRIPTION

Embodiments of methods and apparatus for evolving hypervisor pass-through devices supporting platform independence by MUSE (Mdev in User SpacE) are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

In accordance with aspects of the embodiments disclosed herein, a core solution called MUSE (Mdev in User SpacE) is provided that allows mediated pass-through device being served by software running in user space. The MUSE architecture supports platform hardware independence while providing pass-through performance similar to hardware-specific solutions and providing enhanced performance in virtualized environments without requiring modification to many existing software components, such as operating systems and associated libraries for implementing SDN and VNF.

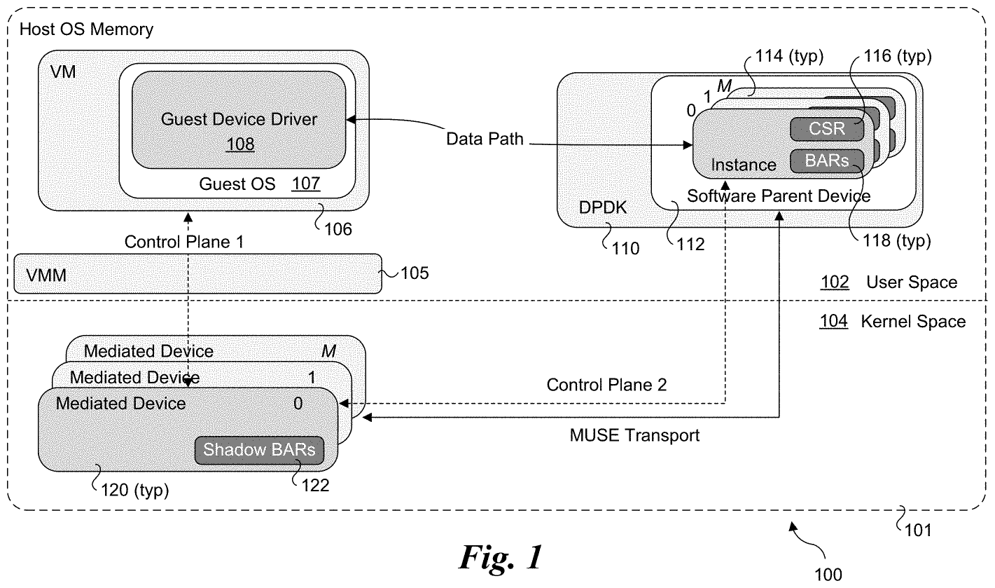

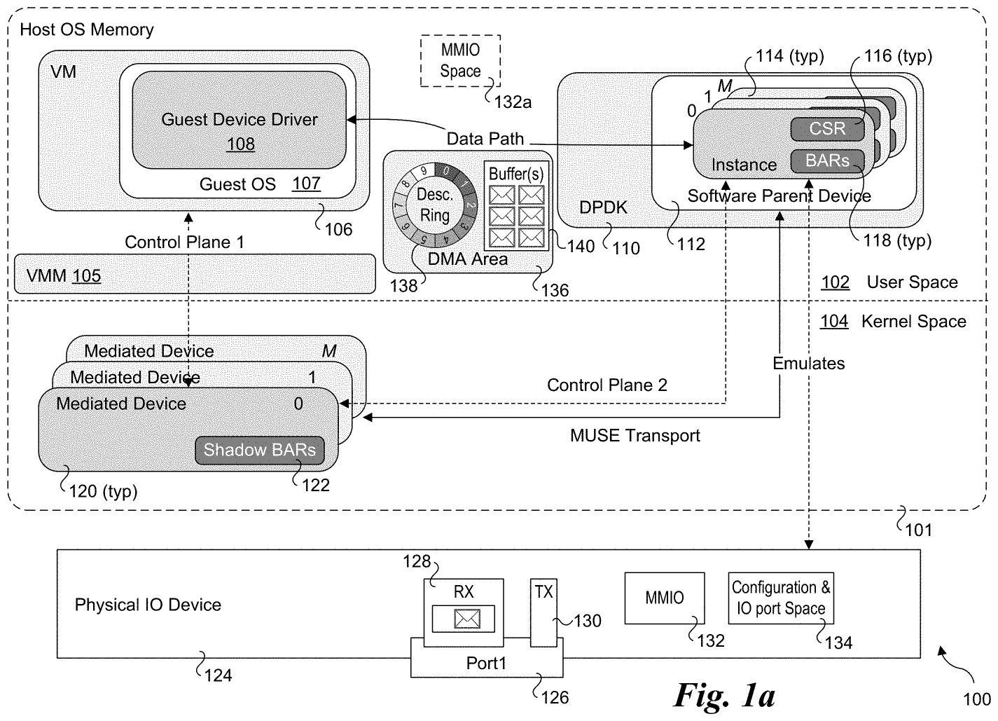

FIG. 1 shows a mediated pass-through architecture 100 with a multi-instance software parent device. The components in architecture 100 are implemented in a host operating system (OS) memory space 101 that is logically partitioned into a User Space 102 and a Kernel Space 104. Software components in User Space 102 include a virtual machine monitor (VMM) 105 (alternatively referred to as a Hypervisor) that is configured to virtualize platform resources utilized by a virtual machine (VM) 106 used to host a guest OS 107 including a guest device driver 108, Data Plane Development Kit (DPDK) components 112, and M instances 114 of a software parent device 112. Each instance 114 includes configuration space registers (CSR) 116 and base address registers (BARs) 118. Software components in Kernel Space 104 include M mediated devices 120, each including a respective set of shadow BARs 122.

Architecture 100 provides mediated pass-through devices for VMs with software parent device implemented in user space. Control plane or slow-path operations of guest device driver 108 in VM 106 are emulated by mediated devices 120 in software. Data path or fast-path operations pass through software parent device 112, bypassing mediated devices 120 and taking advantage of DPDK 110's user space data path, which has been shown to provide substantial performance improvements over slow-path operations. As mentioned, software parent device 112 supports multiple instances 114. In one embodiment, one instance 114 works with one mediated device 120 for one guest. In one embodiment, guest device driver 108 is unmodified vender device driver, and a Virtual Function Input/Output Mediated DEVice (VFIO MDEV) framework is leveraged to provide the mediated devices 120.

To enable some of the functionality supported by architecture 100, four functions are provided: 1) Software parent device; 2) Control plane setup; 3) Data path; and 4) MUSE transport.

Software parent device 112 implements hardware emulation of the platform hardware. It works with guest device driver 108 to provide semantics of the platform hardware. In one embodiment, guest device driver 108 is an unmodified vendor device driver for hardware that is emulated by software parent device 112. Software parent device 112 holds resources such as configuration space resources and serves control plane operation requests from mediated device 120. Those control plane operation requests are initiated by guest device driver 108.

The control plane setup for guest includes the setup of configuration space, Memory-Mapped Input-Output (MMIO) space, Direct Memory Access (DMA) mapping and interrupt setup. The control plane setup includes two operations. The first operation, marked as Control Plane 1 in FIG. 1, is the setup between guest device driver 108 and a mediated device 120. The second operation, marked as Control Plane 2 in FIG. 1, is the setup between a mediated device 120 and an instance 114 of software parent device 112. In one embodiment, the VFIO MDEV framework is leveraged to implement the first operation. The VFIO MDEV framework manages mediated device lifecycle, sets up access policy on a mediated device 120 and serves control plane operations from guest device driver 108.

As mentioned above, the data path provides IO (input-output) for guest device driver 108 passing through software parent device 112. Thus, the data path is implemented entirely in user space 102, bypassing mediated device 120. Performance improvements through implementing the data path in user space is one of the reasons for the success of DPDK, which is widely used in data centers and for cloud-hosted services.

The MUSE transport provides the transport layer between a mediated device 120 and an instance 114 of software parent device 112. Development of the MUSE transport is based, in part, on the FUSE (File System in User Space) framework. The MUSE transport is leveraged to do control plane setup between mediated devices and instances of software parent devices.

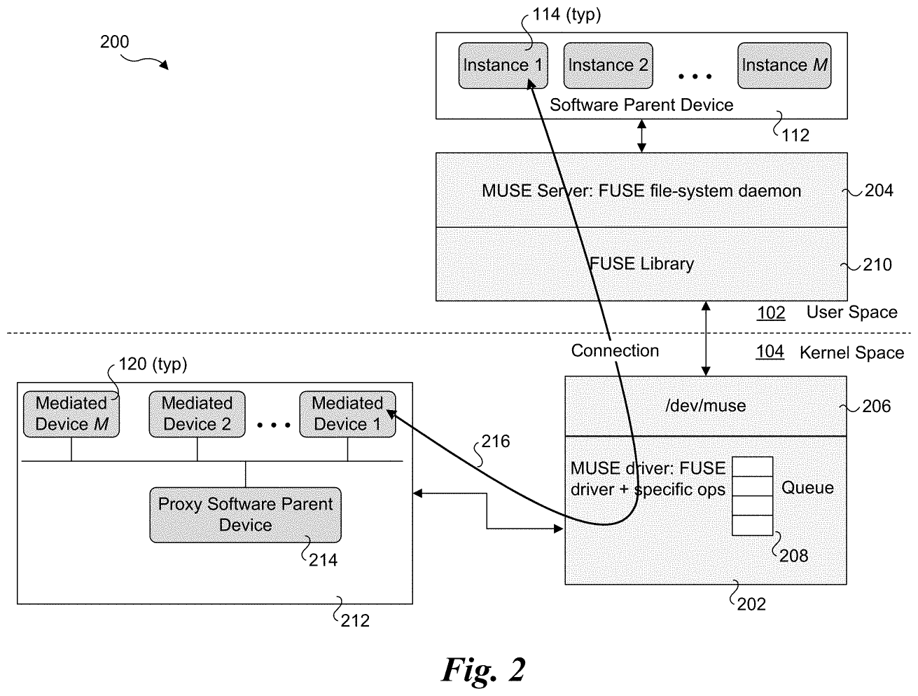

Diagram 200 of FIG. 2 depicts selected components in architecture 100 associated with MUSE operations, wherein components supporting MUSE transport are shown in light gray. The MUSE transport is leveraged to manage mediated device lifecycle and to provide connection for mediated device and software parent device instances.

As shown in FIG. 2, the MUSE transport includes of a kernel part implemented in kernel space 104 called the MUSE driver (202) and a user-level daemon called the MUSE server (204). In addition, there is a character device /dev/muse 206 serving as an interface between MUSE server 204 and MUSE driver 202. As further shown, MUSE driver 202 includes a queue 208, while MUSE server 204 includes a FUSE library 210.

The software components in kernel space 104 also includes a VFIO MDEV framework 212 used by M mediated devices 120 and a proxy software parent device 214. As shown, VFIO MDEV framework 212 communicates with MUSE driver 202. The software components in user space 102 include M instances 114 of software parent device 112, which are in communication with MUSE server 210, as shown.

In one embodiment, MUSE driver 204 is a variation of the existing Linux FUSE driver (see https://github.com/libfuse/libfuse). On the one hand, MUSE driver 204 works with a user space daemon similar to the existing Linux FUSE driver. On the other hand, MUSE driver 204 links to VFIO MDEV framework 212 instead of a virtual file system (VFS).

In one embodiment, MUSE server 210 operates as a FUSE server (through use of FUSE library 210) that responds to connection request from MUSE driver 204 and serves operation request by calling specific operations provided by software parent device 112 instances 114.

Proxy software parent device 214 is a dummy character device created by the MUSE transport, which registers proxy software parent device 214 to VFIO MEDV framework 212 as a parent device with proper parent operations. The dummy character device (proxy software parent device 214) emulates control plane operations or relays control plane operations request to software parent device 112 instances 114 via MUSE driver 202. Under the relay case, proxy software parent device 214 and MUSE driver 202 act as a proxy for various control plane operations implemented in software parent device 112 by sending control plane operation requests initiated by the guest device driver to a software backend device (not shown) and carrying back the result of operations executed in software parent device 112 over the connection. Essentially this character dummy device behaves like a software parent device proxy, so it is called a proxy software parent device (214).

Connections, such as illustrated by a connection 216, provide a communication channel between one mediated device 120 and the corresponding software parent device instance 114 via file operations for read, write and ioctl in the FUSE framework referred to at https://github.com/libfuse/libfuse. In addition to providing connections for connecting mediated device and software parent device instance, the MUSE transport is also leveraged to manage mediated device life-cycle.

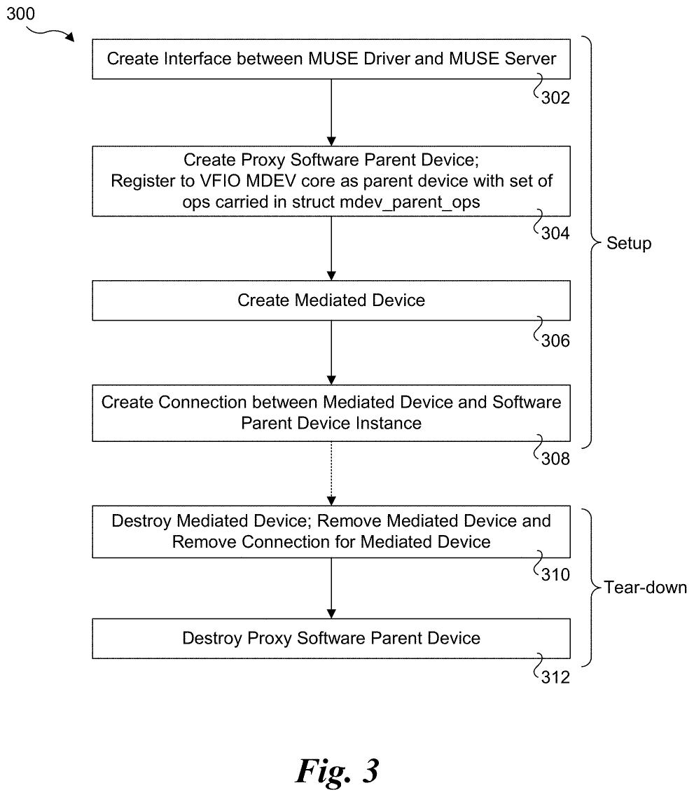

With reference to a flowchart 300 in FIG. 3, the mediated device life-cycle management is as follows. The life-cycle begins in a block 302, wherein the interface between the MUSE driver and the MUSE server is created. On platform initialization, character device /dev/muse is created, which provides the interface. Next, in a block 304 the Proxy software parent device is created. By opening the file /dev/muse, the open operation of file /dev/muse creates a character device as the proxy software parent device and it is register to the VFIO MDEV core as parent device with a set of ops such as “create”, “read”, “write”, “mmap”, etc. carried in struct “mdev_parent_ops” in one embodiment.

In a block 306, the user writes mdev sysfs to create the mediated device of the proxy software parent device. The connection between the mediated device and the software parent device instance is then created in a block 308. In one embodiment, when the guest opens the mediated device, the proxy software parent device triggers the creation of the connection between the mediated device and the software parent device instance.

The remaining portion of the life-cycle are tear-down operations. In a block 310 the mediated device is destroyed by the user writing mdev sysfs to remove the mediated device of the proxy software parent device. Meanwhile, the connection created in block 308 for the destroyed mediated device is removed. The proxy software parent device is then destroyed in a block 310. In one embodiment, stopping the MUSE server triggers the removal of the proxy software parent device and unregisters the registration to VFIO MDEV if there is no mediated device deriving from it.

With the mediated device created, it is ready for control plane set up for the guest. Control plane setup includes setting up an access policy on the software parent device resources and DMA mapping. The resources include interrupt and configuration space accommodating configuration space registers (CSR), MMIO space or IO port space accommodating hardware configuration or status registers such as tail pointer of ring and so on. VFIO MDEV framework is leveraged for setting up access policy on mediated device resources. The proxy software parent device is leveraged to set up access policy on the software parent device resource and to serve control plane operation.

As discussed above, the is a 1:1 relationship between an Mdev instance, a software parent device instance, and a physical IO device that is emulated by the software parent, wherein the software parent device holds resources such as configuration space resources and serves control plane operation requests from the mediated device. In some embodiments, the physical IO device is a network interface controller (NIC), network interface or network adaptor, such as depicted by physical IO device 124 in FIG. 1a. Physical IO device 124 includes one or more ports 126, each coupled to a receive (RX) buffer 128 and a transmit (TX) buffer 130. Physical IO device 124 for includes a MMIO 132, and configuration and IO port space 134. User space 102 further includes a DMA area 136 including a descriptor ring 138 and one or more buffers 140. Descriptor ring 138 is used to store descriptors, while buffer(s) 140 is/are used to store packet data associated with the descriptors. MMIO space 132a corresponds to one or more pages of memory in user space that are mapped to MMIO 132 on Physical IO device 124, as discussed below in further detail.

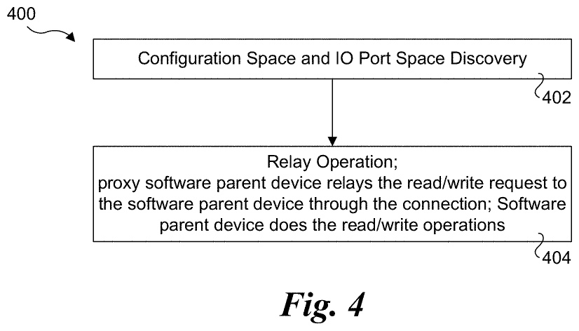

The proxy software parent device uses different methods to serve control plane setup based on the type of resource. For setting up the MMIO space, DMA mapping and interrupt, the proxy software parent device performs the applicable mapping or translation. For setting up the configuration space and IO port space, the proxy software parent device operates as a relay. With reference to flowchart 400 of FIG. 4, the configuration space setup and IO port space setup are as follows.

In a block 402, discovery of the configuration space and IO port space is performed. In one embodiment the guest initiates configuration space and IO port space information discovery during its build device phase (i.e., when the guest driver builds or creates a device instance). The Proxy software parent device relays an information query request or reply to or from it associated software parent device through the connection. In turn, the software parent device serves the query request.

In a block 404 the relay operation is performed. In one embodiment the guest accesses the configuration space and IO port space, such as configuration space and IO port space 134 for physical IO device 124, by initiating a read/write request. The proxy software parent device relays the read/write request to the software parent device through the connection. In this embodiment, the software parent device does the read/write operations.

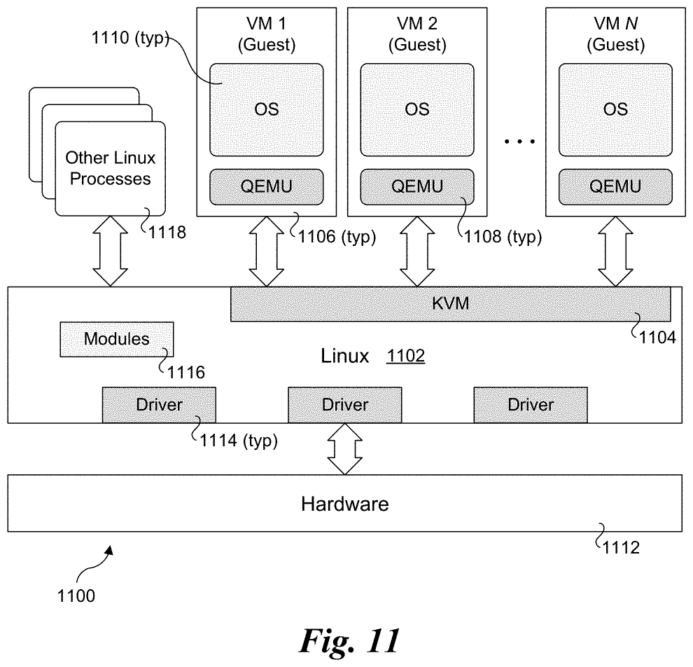

In one embodiment, architecture 100 is implemented using a Linux KVM (Kernel-based Virtual Machine) architecture, such as illustrated in Linux KVM architecture 1100 of FIG. 11. Under modern versions of Linux, Hypervisor functionality is tightly integrated into the Linux code base and provide enhanced performance when compared with VMM and Type-2 Hypervisors that are run as application in the host's user space. As a result, Linux KVM architectures are widely deployed in datacenters and/or to support cloud-based services.

As illustrated in FIG. 11, Linux KVM architecture 1100 employs a Linux operating system 1102 including KVM 1104 that is used to host N virtual machines 1106, which the VMs are also referred to as guests. Each VM 1106 includes QEMU 1108. QEMU (short for Quick EMUlator) is a generic and open source machine emulator that performs platform hardware virtualization and is a hosted virtual machine monitor (VMM). QEMU, which is available from https://www.qemu.org/, is commonly implemented as a VM in today's cloud environments. An instance of an OS 1110 is run in each VM 1106. Under Linux KVM architecture 1100, the OS is implemented as a user space process using QEMU for x86 emulation. Other components illustrated in Linux KVM architecture 1100 include a hardware layer 1112, Linux drivers 1114, Linux modules 1116 and other Linux processes 1118. As will be recognized by those skilled in the virtualization art, the Linux KVM architecture also includes additional components that are implemented in VMs 1106 that are not shown for simplicity. This KVM implementation is referred to as a Hypervisor, observing that unlike some Hypervisor architectures, under the Linux KVM architecture the Hypervisor components are not implemented in a single separate layer (e.g., such as a Type-2 Hypervisor), but rather include software components in the Linux kernel as well as software components in the VMs (implemented in the host's user space).

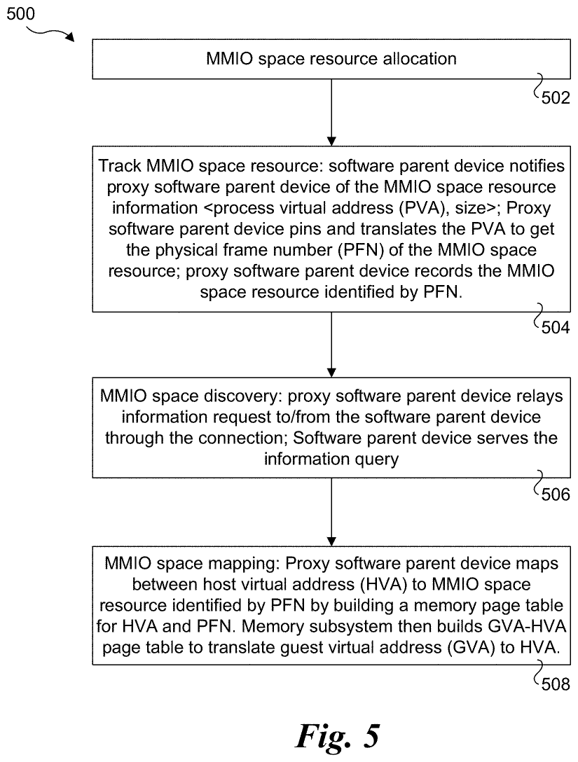

With reference to flowchart 500 of FIG. 5, setup of the MMIO space proceeds as follows. In a block 502 MMIO space resource allocation is performed, such as allocation of MMIO space 132a in FIG. 1a. In one embodiment, the software parent device allocates a continuous block of memory (e.g., one or more pages) as a MMIO space resource. In a block 504, access to the MMIO space resource is tracked. In one embodiment the software parent device notifies the proxy software parent device of the MMIO space resource information <process virtual address (PVA), size>. The proxy software parent device pins and translates the PVA to get the physical frame number (PFN) of the MMIO space resource. The proxy software parent device then records the MMIO space resource identified by PFN.

In a block 506, MMIO space discovery is performed. The guest initiates MMIO space information discovery during its build device phase. The Proxy software parent device relays the information query request or reply to or from the software parent device through the connection, and the software parent device serves the query request.

In a block 508, MMIO space mapping is performed. In one embodiment the proxy software parent device listens for an “mmap” request for MMIO space from QEMU initiated by the guest. The proxy software parent device then maps between host virtual address (HVA) to MMIO space resource identified by PFN by building a memory page table for HVA and PFN. The memory subsystem then builds a guest virtual address (GVA)-HVA page table to translate guest virtual addresses to host virtual address. The GVA-HVA page table enables the guest to access the MMIO space resource using GVA.

Once the MMIO space access is setup, DMA mapping setup is ready to be performed. The DMA area is an area of shared memory in user space that is used by the guest device driver and software parent device to accommodate the descriptor ring and data buffer, such as depicted by DMA area 136 in FIG. 1a. Under conventional operations using a “smart” NIC or similar network device, the NIC performs initial packet processing operations that include writing packet descriptors into a descriptor ring and packet data into a data buffer (or buffers) in user space memory using DMA transfers (referred to as DMA transactions under PCIe). The DMA transfers/transactions are performed via hardware, such as physical IO device 124 without using CPU cycles, hence the name direct memory access, as is known in the art. A portion of shared memory in user space (e.g., DMA area 136) is allocated for such DMA transfers/transactions.

Under some conventional architectures, various user space software, such as QEMU and an operating system network stack, access the descriptor ring and data buffer(s) in the portion of shared memory. Under the embodiments herein, packet descriptors are written to the descriptor ring (e.g., descriptor ring 138) and packet data to data buffer(s) using a virtual mediated device in a manner similar to a smart NIC, but without using DMA transfers/transactions. However, from the viewpoint of the user space software, the area of shared memory that is used by the guest device driver and software parent device to accommodate the descriptor ring and data buffer appears to be similar to the area of shared memory that would be written to by the smart NIC or similar network device. Hence, the area of shared memory is referred to as a “DMA” area in this specification and in the claims, while observing the use of “DMA” shall not be construed as requiring any type of DMA transfer from an IO device into the DMA area.

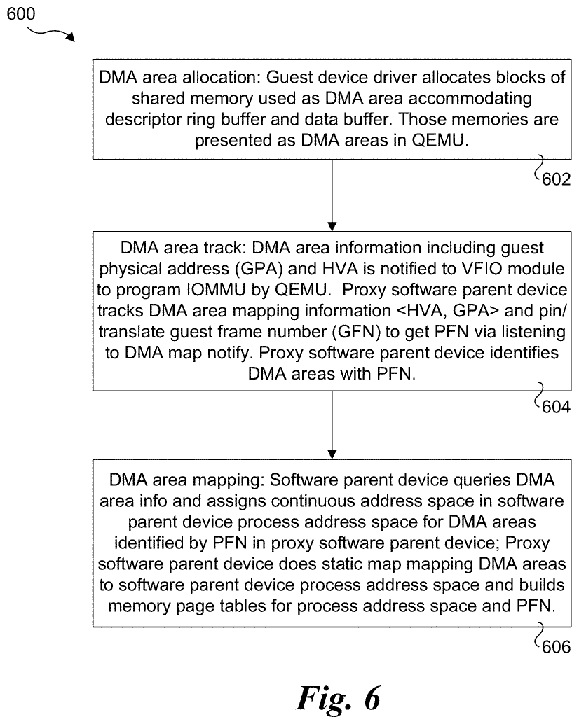

In the mediated pass-through architecture with a multi-instance software parent device, the DMA area and related information is configured to enable the software parent device to access the descriptor ring and data buffer in guest memory space directly without data copy and without an address interpretation at an intermediary layer. With reference to flowchart 600 of FIG. 6, the DMA mapping setup proceeds as follows.

In a block 602, DMA area allocation is performed. In one embodiment, the guest device driver allocates blocks of shared memory used as DMA area accommodating the descriptor ring buffer and data buffer. Those memories are presented as DMA areas in QEMU.

In a block, DMA area tracking is performed. DMA area information including guest physical address (GPA) and HVA is notified to the VFIO module by the QEMU to program the IOMMU (IO Memory Management Unit). However, under embodiments of the MUSE architecture herein there is no IOMMU (noting an IOMMU may exist on the host processor but it is not used). Rather, instead of programming the IOMMU, the proxy software parent device tracks DMA area mapping information <HVA, GPA> and pins/translates the guest frame number (GFN) to get the PFN via listening to the DMA map notification. The proxy software parent device identifies DMA areas with the PFN(s).

In a block 606, DMA area mapping is performed. In one embodiment, the software parent device queries DMA area information and assigns a continuous address space in the software parent device process address space for DMA areas identified by PFN in the proxy software parent device. In one embodiment the proxy software parent device uses a static map mapping DMA area(s) to the software parent device process address space and builds memory page tables for process address space and PFN(s). The mapping and page tables enable the software parent device to access the DMA area using the software parent process address space base as start address and GPA as offset.

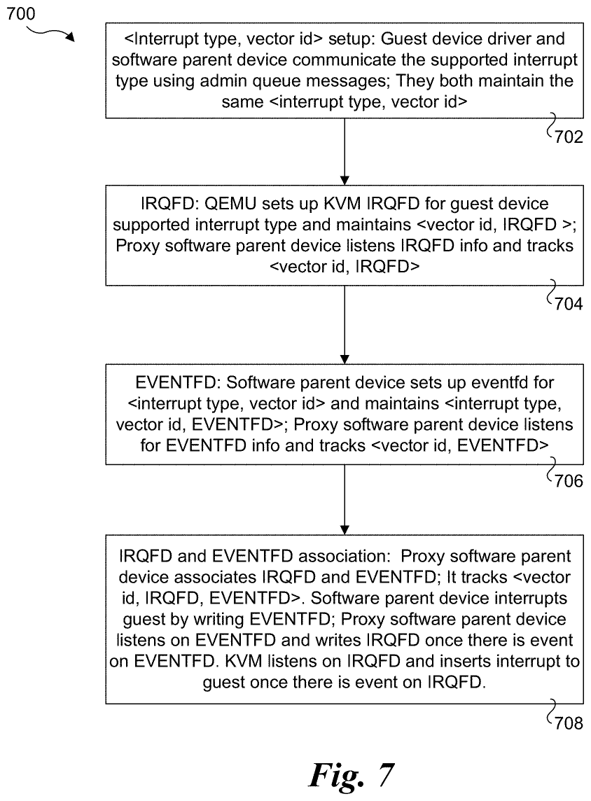

With DMA mapping setup performed, the guest device driver and software parent device are able to transfer packet data between them. One use case is admin queue message. Interrupt/Doorbell setup needs admin queue message to exchange information. The Doorbell is used by the guest to kick the software parent device and the interrupt is used by the software parent device to interrupt the guest when something happens in the software parent device. With reference to flowchart 700 of FIG. 7, interrupt delivery setup proceeds as follows.

The process being in a block 702 in which <Interrupt type, vector id> is setup. In one embodiment, the guest device driver and software parent device communicate the supported interrupt type using admin queue messages. They both maintain the same <interrupt type, vector id> pairing(s).

Next, in a block 704 IRQFD is setup. IRQFD (or irqfd) is a mechanism to inject a specific interrupt to a guest using a decoupled EVENTFD (event file descriptor) mechanism. QEMU sets up a KVM (Kernel Virtual Machine) IRQFD for guest device supported interrupt type and maintains a <vector id, IRQFD> entry. The Proxy software parent device listens for the IRQFD information and tracks occurrences of <vector id, IRQFD>.

In a block 706 the EVENTFD is set up. The Software parent device sets up eventfd for <interrupt type, vector id> and maintains a <interrupt type, vector id, EVENTFD> tuple. The Proxy software parent device listens EVENTFD info and tracks <vector id, EVENTFD>.

The process is completed in a block 708 in which an IRQFD and EVENTFD association is created. The Proxy software parent device associates IRQFD and EVENTFD and tracks <vector id, IRQFD, EVENTFD> tuples. The software parent device interrupts the guest by writing EVENTFD. The Proxy software parent device listens on EVENTFD and writes IRQFD once there is event on EVENTFD. The KVM listens on IRQFD and inserts an interrupt to the guest once there is event on IRQFD.

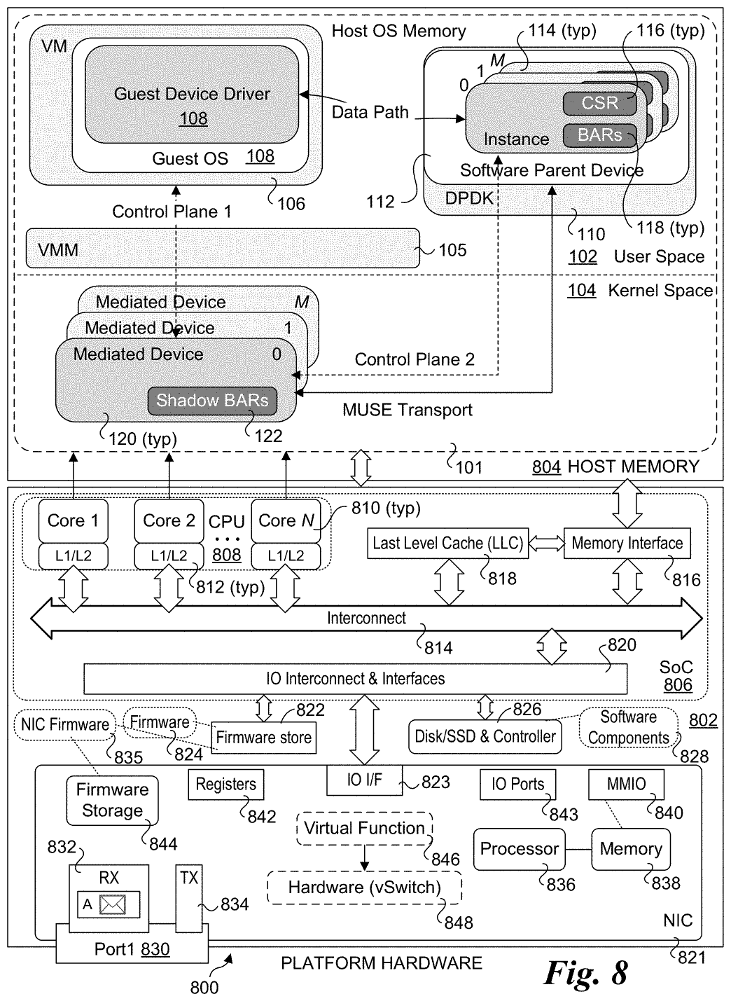

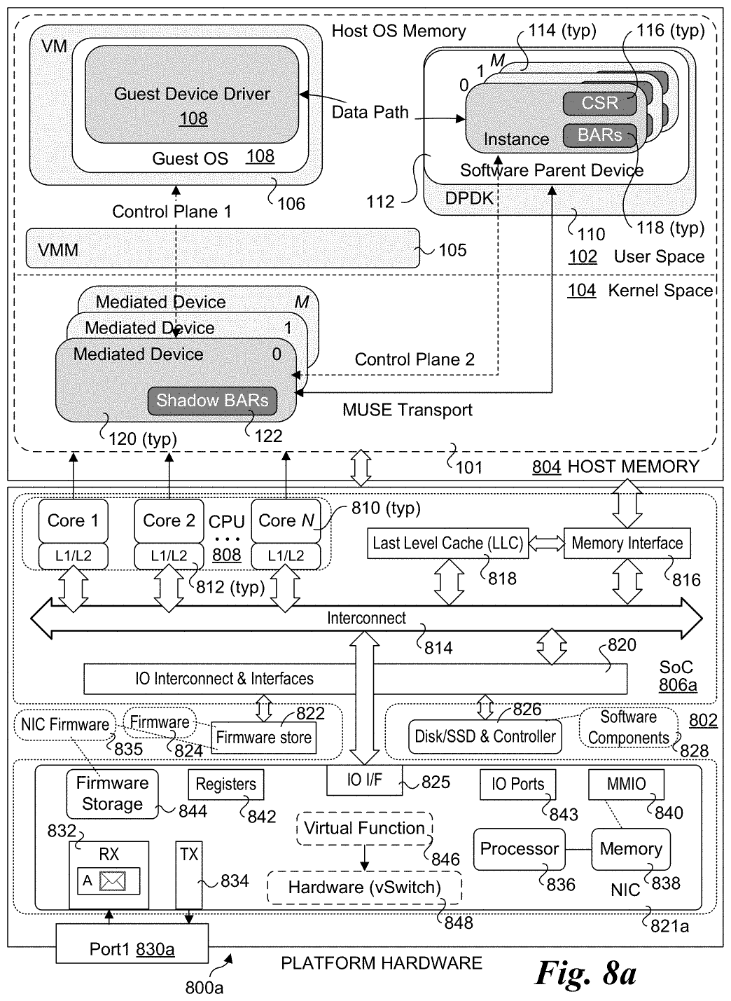

FIG. 8 shows one embodiment of a platform architecture 800 corresponding to a computing platform suitable for implementing aspects of the embodiments described herein. Architecture 800 includes a hardware layer in the lower portion of the diagram including platform hardware 802, and a software layer that includes software components running in host memory 804.

Platform hardware 802 includes a processor 806 having a System on a Chip (SoC) architecture including a central processing unit (CPU) 808 with N processor cores 810, each coupled to a Level 1 and Level 2 (L1/L2) cache 812. Each of the processor cores and L1/L2 caches are connected to an interconnect 814 to which each of a memory interface 816 and a Last Level Cache (LLC) 818 is coupled, forming a coherent memory domain. Memory interface is used to access host memory 804 in which various software components are loaded and run via execution of associated software instructions on processor cores 810.

Processor 806 further includes an IO interconnect hierarchy, which includes one or more levels of interconnect circuitry and interfaces that are collectively depicted as IO interconnect & interfaces 820 for simplicity. Various components and peripheral devices are coupled to processor 806 via respective interfaces (not all separately shown), including a NIC 821 via an IO interface 823, a firmware storage device 822 in which firmware 824 is stored, and a disk drive or solid state disk (SSD) with controller 826 in which software components 828 are stored. Optionally, all or a portion of the software components used to implement the software aspects of embodiments herein may be loaded over a network (not shown) accessed, e.g., by MC 821. In one embodiment, firmware 824 comprises a BIOS (Basic Input Output System) portion and additional firmware components configured in accordance with the Universal Extensible Firmware Interface (UEFI) architecture.

During platform initialization, various portions of firmware 824 (not separately shown) are loaded into host memory 804, along with various software components. In architecture 800 of FIG. 8 the software components include the same components shown in architecture 100 of FIG. 1. In addition, other software components would be implemented, such as various components for a host operating system.

NIC 821 includes one or more network ports 830, with each network port having an associated receive (RX) queue 832 and transmit (TX) queue 834. NIC 821 includes circuitry for implementing various functionality supported by the NIC. For example, in some embodiments the circuitry may include various types of embedded logic implemented with fixed or programmed circuitry, such as application specific integrated circuits (ASICs) and Field Programmable Gate Arrays (FPGAs) and cryptographic accelerators (not shown). NIC 821 may implement various functionality via execution of NIC firmware 835 or otherwise embedded instructions on a processor 836 coupled to memory 838. One or more regions of memory 838 may be configured as MMIO memory 840. NIC further includes registers 842, IO ports 843, firmware storage 844, one or more optional virtual functions 846 and a hardware virtual switch (vSwitch) 848. Generally, NIC firmware 835 may be stored on-board NIC 421, such as in firmware storage device 844, or loaded from another firmware storage device on the platform external to NIC 821 during pre-boot, such as from firmware store 822. NIC 821 also

[symbol]

FIG. 8a shows a platform architecture 800a including an SoC 806a having an integrated NIC 821a configured in a similar manner to NIC 421 in platform architecture 800, with the following differences. Since NIC 421a is integrated in the SoC it includes an internal interface 425 coupled to interconnect 414 or another interconnect level in an interconnect hierarchy (not shown). RX buffer 832 and TX buffer 832 are integrated on SoC 806A and are connected via wiring to port 830a, which is a physical port having an external interface. In one embodiment, SoC 806a further includes IO interconnect and interfaces and platform hardware includes firmware, a firmware store, disk/SSD and controller and software components similar to those shown in platform architecture 800.

The CPUs 808 in SoCs 806 and 806a may employ any suitable processor architecture in current use or developed in the future. In one embodiment, the processor architecture is an Intel® architecture (IA), including but not limited to an Intel® x86 architecture, and IA-32 architecture and an IA-64 architecture. In one embodiment, the processor architecture is an ARM®-based architecture.

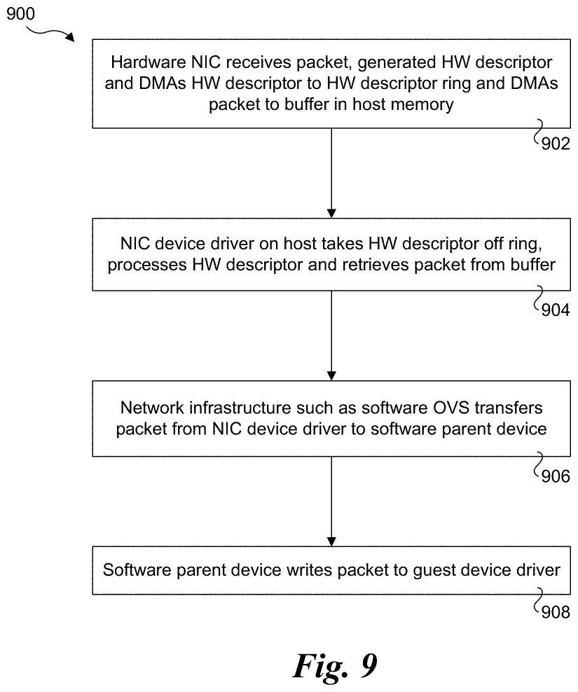

FIG. 9 shows a flowchart 900 illustrating operations for processing a packet received by NIC when the guest device driver does not support the NIC. The process begins in a block 902 in which the hardware NIC (e.g., NIC 821 of FIG. 8) receives a packet. As part of initial packet processing operations performed by the NIC a hardware descriptor is generated and written using a DMA operation to a HW descriptor ring in host memory set up be the hardware NIC device driver. In parallel, the NIC DMAs the packet data into a buffer in host memory at a location indicated by the HW descriptor.

In a block 904 the NIC device driver on the host takes the HW descriptor off the HW descriptor ring and processes it to identify the location of the packet in the buffer, and the retrieves the packet from that location. In a block 906 network infrastructure, such as a software Open vSwitch (OVS) transfers the packet from the NIC device driver to an instance of the software parent device. The software parent device then writes the packet to the guest device driver to complete the process in a block 908. At this point the packet can be processed by applicable software components in the guest OS.

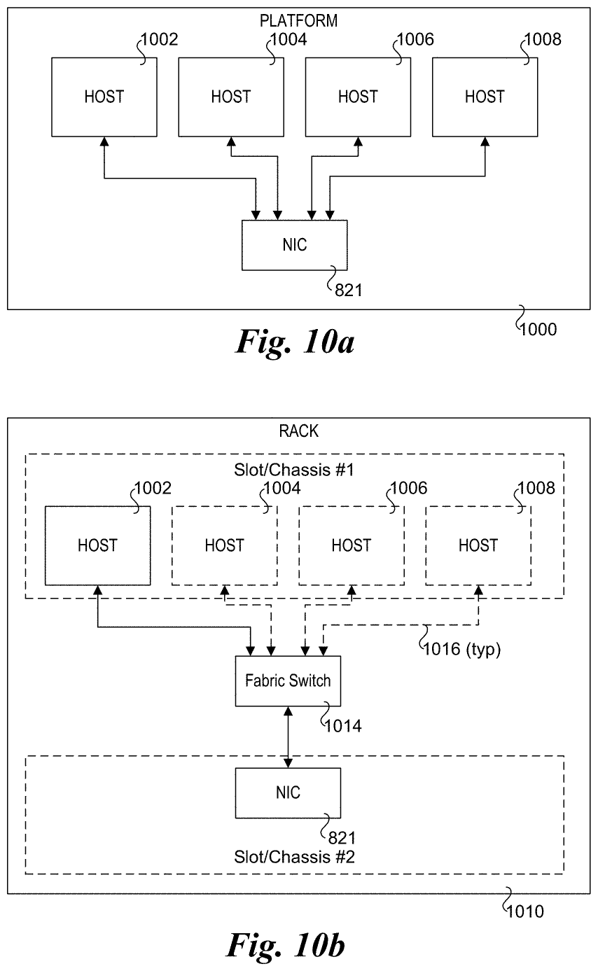

In addition to a network controller or NIC being connected to a single host, the network controller or NIC may be connected to multiple hosts, with one or more of the hosts having software configured similar to that shown for software layer 804 in FIG. 8. For example, FIG. 10a shows a platform 1000 including a NIC 821 connected to each of hosts 1002, 1004, 1006, and 1008.

As shown in FIG. 10b, a NIC can be installed in a rack in a slot, chassis, tray or sled that is separate from a slot, chassis, tray or sled in which one or more hosts connected to the NIC are installed. In this example, NIC 821 is installed in a slot or chassis #2 in a rack 1010 including multiple slots. One or more hosts 1002, 1004, 1006, and 1008 are installed in a slot or chassis #1. NIC 821 is coupled in communication with one or more of hosts 1002, 1004, 1006, and 1008 via a fabric switch 1014 and fabric links 1016. In other embodiments, a NIC may be coupled in communication with a host in a separate slot or chassis via a point-to-point link. In still other embodiments, a NIC may be coupled in communication with a host in a separate rack (not shown).

In accordance with aspects of the embodiments disclosed herein, a core solution based on MUSE is provided that allows mediated pass-through device being served by software running in user space. As an alternative, Mdev backed with a hardware device, its ‘para-virtualized form’ properties are more cloud-ready friendly as a software fallback for different types of device switchover (e.g., live-migration, failure protection, hot upgrade/fix). Except during a device's switchover period, Mdev backed with hardware device offers network functions with almost the same performance as compared with hardware device pass-through.

The foregoing embodiments provide several advantages over existing approaches. The solutions' high performance and platform independent enabling cross-platform deployment of network functions interface accelerates NFV deployment in which SDN data plane software such as DPDK, Linaro's OpenDataPlane software and SDN software employing the OpenFlow communications protocol are implemented.

The platform independent aspect of the embodiments supports deployment of a network function originally built on a specific network interface (e.g., NIC provided by various vendors) to a standard severe platform, whether that network interface is hardware native or not. Another advantage is the software architecture is cloud-ready oriented. It makes it possible to provide consistent functions by Mdev, while the hardware device contributes the value of extra performance boost. The entire software stack ecosystem (QEMU, libvirt, openstack, etc.) built around Mdev are reused without modification.

In addition, moving the IO device emulation part out of QEMU provides a substantial advantage to scale out its benefit to other KVM-based hypervisors and VFIO-based container network functions. The embodiments support an abstracted software platform architecture implemented with different device types, (e.g. Intel® NIC, Intel® QAT, NVME, etc.) and different buses and interconnect technologies (including PCIe, platform, ccw (channel-command words), etc.)

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As discussed above, various aspects of the embodiments herein may be facilitated by corresponding software and/or firmware components and applications, such as software and/or firmware executed by an embedded processor or the like. Thus, embodiments of this invention may be used as or to support a software program, software modules, firmware, and/or distributed software executed upon some form of processor, processing core or embedded logic a virtual machine running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

Italicized letters, such as ‘M’, ‘N’, etc. in the foregoing detailed description are used to depict an integer number, and the use of a particular letter is not limited to particular embodiments. Moreover, the same letter may be used in separate claims to represent separate integer numbers, or different letters may be used. In addition, use of a particular letter in the detailed description may or may not match the letter used in a claim that pertains to the same subject matter in the detailed description.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method implemented on a host platform including a first physical input-output (IO) device and a host operating system (OS) having a kernel space and a user space, comprising:
implementing a first instance of a mediated device (Mdev) in the kernel space of the host OS;
implementing a first instance of a software parent device in the user space of the host OS, the first instance of the software parent device associated with the first instance of the Mdev and emulating the first physical IO device; and
hosting a virtual machine (VM) in the user space, the VM running a guest OS having a guest device driver for the first physical IO device and configured to interface with the first instance of the Mdev.

2. The method of claim 1, further comprising:
setting up a first control plane between the guest device driver and the first instance of the Mdev; and
setting up a second control plane between the first instance of the Mdev and the first instance of the software parent device.

3. The method of claim 1, further comprising set up a data path from the guest device driver through the first instance of the software parent device, wherein the data path bypassed the first instance of the Mdev.

4. The method of claim 1, further comprising implementing a transport layer between the first instance of the Mdev and the first instance of the software parent device;
implementing a proxy software parent device in the kernel space of the host OS; and
employing the transport layer and the proxy software parent device to facilitate communication between the first instance of the Mdev and the first instance of the software parent device.

5. The method of claim 4, wherein the first physical IO device includes a configuration space and an IO space, further comprising:
discovering the configuration space and IO space of the first physical IO device; and
employing the proxy software parent device to relay read and write requests to and from the first instance of the software parent device.

6. The method of claim 4, further comprising setting up a memory-mapped input-output (MMIO) space, including:
allocating, via the first instance of the software parent device, a MMIO space resource;
tracking the MMIO space resource, wherein the software parent device notifies the proxy software parent device of MMIO resource space information;
performing MMIO space discovery; and
performing MMIO space mapping including building a guest virtual address (GVA) to host virtual address (HVA) table to translate guest virtual addresses to host virtual addresses.

7. The method of claim 1, further comprising setting up a direct memory access (DMA) area comprising an area of shared memory in user space that is enabled to be accessed by the guest device driver and the first instance of the software parent device and is set up to accommodate a descriptor ring and one or more data buffers

8. The method of claim 7, further comprising enabling the first instance of the software parent device to access the descriptor ring and a data buffer in the DMA area directly without data copy and without an address interpretation at an intermediary layer.

9. The method of claim 1, wherein the host OS is a Linux operating system including a kernel virtual machine (KVM) and the VM is implemented using a QEMU hosted virtual machine monitor (VMM), further comprising:
employing QEMU to set up a KVM IRQFD for a guest device supported interrupt type;
employing the first instance of the software parent device to set up an EVENTFD (event file descriptor); and
associating the IRQFD with the EVENTFD.

10. The method of claim 1, wherein the host platform includes a plurality of physical IO devices including the first physical IO device, further comprising:
implementing a plurality of Mdev instances including the first instance of the Mdev in the kernel space of the host OS, each of the plurality of Mdev instances associated with a respective physical IO device; and
implementing a plurality of instances of the software parent device including the first instance of a software parent device in the user space of the host OS, each instance of the software parent device associated with a respective Mdev instance and emulating a respective physical IO device.

11. A non-transitory machine-readable medium having a plurality of instructions comprising software components stored thereon configured to be executed on a processor in a host platform running a host operating system (OS) and including one or more physical input-output (IO) devices and hosting a virtual machine (VM) in a user space of the host OS including a guest OS and one or more guest device drivers associated with the one or more physical IO devices, the software components comprising:
a mediated device (Mdev) component, configured to implement instances of mediated devices in a kernel space of the host OS, each Mdev instance to be associated with a respective physical IO device among the one or more physical IO devices and configured to interface with a guest device driver for the respective physical IO device; and
a software parent device component, configured to implement instances of a software parent device in a user space of the host OS, each software parent device instance to be associated with a respective Mdev instance and configured to emulate a respective physical IO device.

12. The non-transitory machine-readable medium of claim 11, wherein the plurality of instructions, upon execution, enable the host platform to:
create a first Mdev instance associated with a first physical IO device from among the one or more physical IO devices;
create a first instance of a software parent device configured to emulate the first physical IO device;
set up a first control plane between a guest device driver and the first Mdev instance; and
set up a second control plane between the first Mdev instance and the first instance of the software parent device.

13. The non-transitory machine-readable medium of claim 12, wherein the plurality of instructions, upon execution, further enable the host platform to:
set up a data path in user space from the guest device driver through the first instance of the software parent device.

14. The non-transitory machine-readable medium of claim 11, wherein the plurality of instructions, upon execution, enable the host platform to:
create a first Mdev instance associated with a first physical IO device from among the one or more physical IO devices;
create a first instance of a software parent device configured to emulate the first physical IO device;
implement a transport layer between the first Mdev instance and the first instance of the software parent device; and
implement a proxy software parent device in the kernel space of the host OS; and
employ the transport layer and the proxy software parent device to facilitate communication between the first Mdev instance and the first instance of the software parent device.

15. The non-transitory machine-readable medium of claim 14, wherein the first physical IO device includes a configuration space and an IO space, wherein the plurality of instructions, upon execution, further enable the host platform to:
discover the configuration space and IO space of the first physical IO device; and
employ the proxy software parent device to relay read and write requests to and from the first instance of the software parent device.

16. The non-transitory machine-readable medium of claim 14, wherein the plurality of instructions, upon execution, further enable the host platform to set up a memory-mapped input-output (MMIO) space, by:
allocating, via the first instance of the software parent device, a MMIO space resource;
tracking the MMIO space resource, wherein the software parent device notifies the proxy software parent device of MMIO resource space information;
performing MMIO space discovery; and
performing MMIO space mapping including building a guest virtual address (GVA) to host virtual address (HVA) table to translate guest virtual addresses to host virtual addresses.

17. The non-transitory machine-readable medium of claim 11, wherein the plurality of instructions, upon execution, enable the host platform to:
create a first Mdev instance associated with a first physical IO device;
create a first instance of a software parent device configured to emulate the first physical IO device;
set up a direct memory access (DMA) area comprising an area of shared memory in user space that is enabled to be accessed by the guest device driver and the first instance of the software parent device and is set up to accommodate a descriptor ring and one or more data buffers.

18. The non-transitory machine-readable medium of claim 17, wherein the first instance of the software parent device is enabled to access the descriptor ring and a data buffer in the DMA area directly without data copy and without an address interpretation at an intermediary layer.

19. The non-transitory machine-readable medium of claim 1, wherein the host OS is a Linux operating system including a kernel virtual machine (KVM) and the VM is implemented using a QEMU hosted virtual machine monitor (VMM), an wherein execution of the plurality of instructions further enables the host platform to:
set up a KVM IRQFD for a guest device supported interrupt type;
set up an EVENTFD (event file descriptor); and
associate the IRQFD with the EVENTFD.

20. The non-transitory machine-readable medium of claim 11, wherein the one or more physical IO devices comprise a plurality of physical IO devices, and wherein execution of the plurality of instructions enables the host platform to:
implement a plurality of Mdev instances in the kernel space of the host OS, each of the plurality of Mdev instances associated with a respective physical IO device; and
implement a plurality of instances of the software parent device in the user space of the host OS, each instance of the software parent device associated with a respective Mdev instance and configured to emulate a respective physical IO device.

21. A compute platform, comprising:
a processor, having a plurality of cores and a Peripheral Component Interconnect Express (PCIe) interface;
memory, communicatively coupled to the processor;
one or more physical input-output (IO) devices, communicatively coupled to the PCIe interface;
a storage device, communicatively coupled to the processor; and
a plurality of instructions stored in at least one of the storage device and memory and configured to be executed on at least a portion of the plurality of cores, the plurality of instructions comprising a first plurality of software components associated with a host operating system (OS) configured to host a virtual machine (VM) in a user space of the host OS including a guest OS and one or more guest device drivers associated with the one or more physical IO devices and a second plurality of software components including,
a mediated device (Mdev) component, configured to implement instances of mediated devices in a kernel space of the host OS, each Mdev instance to be associated with a respective physical IO device among the one or more physical IO devices and configured to interface with the guest OS; and
a software parent device component, configured to implement instances of a software parent device in a user space of the host OS, each software parent device instance to be associated with a respective Mdev instance and configured to emulate a respective physical IO device.

22. The compute platform of claim 21, wherein the plurality of instructions, upon execution, enable the compute platform to:
create a first Mdev instance associated with a first physical IO device from among the one or more physical IO devices;
create a first instance of a software parent device configured to emulate the first physical IO device;
set up a first control plane between a guest device driver and the first Mdev instance; and
set up a second control plane between the first Mdev instance and the first instance of the software parent device.

23. The compute platform of claim 22, wherein the plurality of instructions, upon execution, further enable the compute platform to:
set up a data path in user space from the guest device driver through the first instance of the software parent device.

24. The compute platform of claim 22, wherein the plurality of instructions, upon execution, enable the compute platform to:
create a first Mdev instance associated with a first physical IO device from among the one or more physical IO devices;
create a first instance of a software parent device configured to emulate the first physical IO device;
implement a transport layer between the first Mdev instance and the first instance of the software parent device; and
employ the transport layer to provide communication between the first Mdev instance and the first instance of the software parent device to set up the second control plane.

25. The compute platform of claim 21, wherein the host OS is a Linux operating system including a kernel virtual machine (KVM) and the VM is implemented using a QEMU hosted virtual machine monitor (VMM), wherein the one or more physical IO devices includes a network device having an associated guest network device driver, and wherein the plurality of instructions, upon execution, enable the compute platform to:
create an Mdev instance associated with the network device;
create an instance of a software parent device configured to emulate the network device;
set up a first control plane between the guest network device driver and the Mdev instance; and
set up a second control plane between the Mdev instance and the instance of the software parent device.
